(19) United States
(12) Patent Application Publication
(10) Pub. No.: US 2015/0051820 A1
(43) Pub. Date: Feb. 19, 2015

(54) Method for Preparing the Start-Up of an Internal Combustion Engine With the Aid of a Belt-Driven Starter Generator

(71) Applicants: Andreas JACOB, Blaubeuren (DE); Matthias SCHMIDT, Stuttgart (DE); ROBERT BOSCH GMBH, Stuttgart (DE)

(72) Inventors: Matthias Schmidt, Stuttgart (DE); Andreas Jacob, Stuttgart (DE)

(73) Assignee: Robert Bosch GmbH, Stuttgart (DE)

(21) Appl. No.: 14/383,167

(22) PCT Filed: Jan. 24, 2013
(86) PCT No.: PCT/EP2013/051291

§ 371 Date: Sep. 5, 2014

(30) Foreign Application Priority Data
Mar. 5, 2012 (DE) 102012203374.2

(51) Int. Cl. F02N 11/08

(52) U.S. Cl. CPC F02N 11/08
USPC 701/113

(57) ABSTRACT

A method for preparing a start-up of an internal combustion engine with a belt-driven starter generator having a stator and rotor windings, the starter generator being operated so that its generated torque slowly increases over a period of more than two rotor winding-time constants. The stator winding is energized so that the generated torque slowly increases over a period of more than two rotor winding-time constants. The rotor winding is energized and, when a field current through the rotor winding is below a lower threshold value prior to the beginning of its energization, the stator winding is energized, before the field current is above an upper threshold value. The belt of the starter generator is pre-tensioned prior to the actual starting operation by activating the electric machine so that jolts, vibrations and noises, which occur during the start-up of the internal combustion engine with a starter generator, may be avoided.

### FIELD OF THE INVENTION

The present invention relates to a method for preparing the start-up of an internal combustion engine with the aid of a belt-driven starter generator as well as to an arithmetic unit for carrying out this method.

### BACKGROUND INFORMATION

Electric machines may be used in motor vehicles as so-called starter generators in order to, on the one hand, start the internal combustion engine during engine operation of the electric machines and, on the other hand, to generate power for the vehicle electrical system and to charge the battery of the motor vehicle during generator operation of the electric machines. Starter generators may be connected to the internal combustion engine or the crankshaft via a belt drive.

Externally excited three-phase synchronous machines are, in particular, suitable for use as belt-driven starter generators (BSGs), since their motor-based torque is controllable particularly well. A desirable torque may be set by correspondingly controlling the rotor winding (field coil) and/or the stator winding (three or five stator phases are common, for example). A torque modulation over time may be used in order to achieve a starting operation which may be low in noise and vibration.

German patent document DE 10 2005 034 123 A1 refers to a belt three-phase generator starter system for a vehicle. If the ignition is turned on and the internal combustion engine is turned off, a current flowing through a rotor winding of a three-phase generator starter device is set to a pre-flow field current and a current flowing through a stator winding is set to zero. If a starting command for starting the internal combustion engine is received, the current flowing through the rotor winding and the current flowing through the stator winding are each set to a starting current value.

In order to reduce slip during belt drive, belt tensioners, such as the so-called reciprocating tensioning systems, may be used. As a result of the tight side and slack side alternating during engine-based operation and generator-based operation excitation field build-up is energized. This results in a slower increase of the torque.

### SUMMARY OF THE INVENTION

According to the present invention, a method for preparing the start-up of an internal combustion engine with the aid of a belt-driven starter generator having the features described herein. Advantageous embodiments are the subject matter of the subclaims as well as of the following description.

The present invention provides the pre-tensioning of the belt of a BSG prior to the actual starting operation by activating the electric machine. For this purpose, the torque, which is generated by the BSG, is increased slowly and not joltily as in the case of the related art. This may be achieved by a particular energization of the stator winding.

The beginning of the energization of the stator winding takes place according to the present invention as a function of current and/or time. The stator winding may be energized before the excitation current flowing through the rotor winding is above an upper threshold value (of 10%, 25%, 50%, or 75% of the excitation current used for starting the internal combustion engine, for example) and/or within no more than two rotor winding time constants after the beginning of the energization of the rotor winding, which may be within no more than one or within no more than a quarter of the rotor winding time constant. Accordingly, the upper threshold value may be between approximately 1 A and 7 A (the energization takes place within approximately 10 ms to 100 ms).

The slowly increasing torque progression which is caused within the scope of the present invention may be used to pre-tension the belt and thus to ensure a rapid engine start which is low in noise and vibration. Due to the slow (in particular, ramp-shaped) torque increase, a potentially present reciprocating tensioning system may slowly cease vibrating. In this way, the noise generation and the occurring vibrations, such as the one occurring due to a jolty tensioning of a belt, are avoided.

At the beginning of the torque increase, the torque acting on the crankshaft is not yet sufficient to crank the internal combustion engine. The size of the torque is, however, sufficient to tension the belt. Now, as soon as a sufficient amount of torque acts on the crankshaft, the internal combustion engine immediately starts cranking. Since the stator winding is usually not energized until the rotor winding is excited and at this point in time, the belt is not yet tensioned either, the present invention results in twice as much time being saved, since according to the present invention, the energization of the stator winding already takes place at an earlier point in time and the belt is already pre-tensioned, when the required torque is available. A reduction of the jolt on the belt and on an associated (reciprocating) belt tensioning system reduces the mechanical load and is thus component-preserving. In this way, an increase in the service life may be achieved with an identical configuration.

The stator winding may be already energized before the excitation current has reached its maximum, which may be already within two time constants after the beginning of the energization of the rotor winding, and which may be within one time constant. Due to its great inductance, the rotor winding has a relatively large time constant (inductance divided by resistance, usually several 100 ms), so that consequently, a certain period of time is necessary until the desirable excitation current actually flows after the beginning of energization of the rotor winding.

If the rotor winding is essentially de-energized (i.e., the excitation current flowing through the rotor winding is below a lower threshold value of 50% or 25%, for example, of the excitation current used to start the internal combustion engine), the relatively large time constant of the rotor winding may be advantageously utilized. This effect of the slow excitation field build-up, which is undesirable in the related art, may be used when the stator winding is energized simultaneously already during the excitation field build-up.

This results in a slower increase of the torque. The beginning of the energization of the stator winding may take place as a function of current and/or time. The stator winding may be energized before the excitation current flowing through the rotor winding is above an upper threshold value (of 10%, 25%, 50%, or 75% of the excitation current used for starting the internal combustion engine, for example) and/or within no more than two rotor winding time constants after the beginning of the energization of the rotor winding, which may be within no more than one or within no more than a quarter of the rotor winding time constant. Accordingly, the upper threshold value may be between approximately 1 A and 7 A (the energization takes place within approximately 10 ms to 100 ms).

The slowly increasing torque progression which is caused within the scope of the present invention may be used to pre-tension the belt and thus to ensure a rapid engine start which is low in noise and vibration. Due to the slow (in particular, ramp-shaped) torque increase, a potentially present reciprocating tensioning system may slowly cease to reciprocate. In this way, the noise generation and the occurring vibrations, such as the one occurring due to a jolty tensioning of a belt, are avoided.

At the beginning of the torque increase, the torque acting on the crankshaft is not yet sufficient to crank the internal combustion engine. The size of the torque is, however, sufficient to tension the belt. Now, as soon as a sufficient amount of torque acts on the crankshaft, the internal combustion engine immediately starts cranking. Since the stator winding is usually not energized until the rotor winding is excited and at this point in time, the belt is not yet tensioned either, the present invention results in twice as much time being saved, since according to the present invention, the energization of the stator winding already takes place at an earlier point in time and the belt is already pre-tensioned, when the required torque is available. A reduction of the jolt on the belt and on an associated (reciprocating) belt tensioning system reduces the mechanical load and is thus component-preserving. In this way, an increase in the service life may be achieved with an identical configuration.

An arithmetic unit according to the present invention, e.g., a control unit of a motor vehicle, is configured to carry out a method according to the present invention, in particular from a programming point of view.

It is also advantageous to implement the method in the form of software, since this is particularly cost-effective, in particular when an executing control unit is used for other tasks and is thus present anyway. Suitable data carriers for providing the computer program are, in particular, floppy disks, hard drives, flash memories, EEPROMs, CD-ROMs, DVDs, and many others. It is also possible to download a program via computer networks (Internet, Intranet, etc.).

Further advantages and embodiments of the present invention result from the description and the appended drawing.

It is understood that the above-mentioned features and the features to be elucidated below are usable not only in the given combination, but also in other combinations or alone without departing from the scope of the present invention.

The present invention is schematically illustrated in the drawing on the basis of an exemplary embodiment and is described in greater detail below with reference to the drawing.

### BRIEF DESCRIPTION OF THE DRAWINGS

FIG. 1 schematically shows a system including an internal combustion engine, a belt-driven starter generator, and a vehicle electrical system, such as the ones on which the present invention may be based.

FIG. 2 shows one specific embodiment of a starter generator including a current converter having controllable switching elements, such as the one on which the present invention may be based.

### DETAILED DESCRIPTION

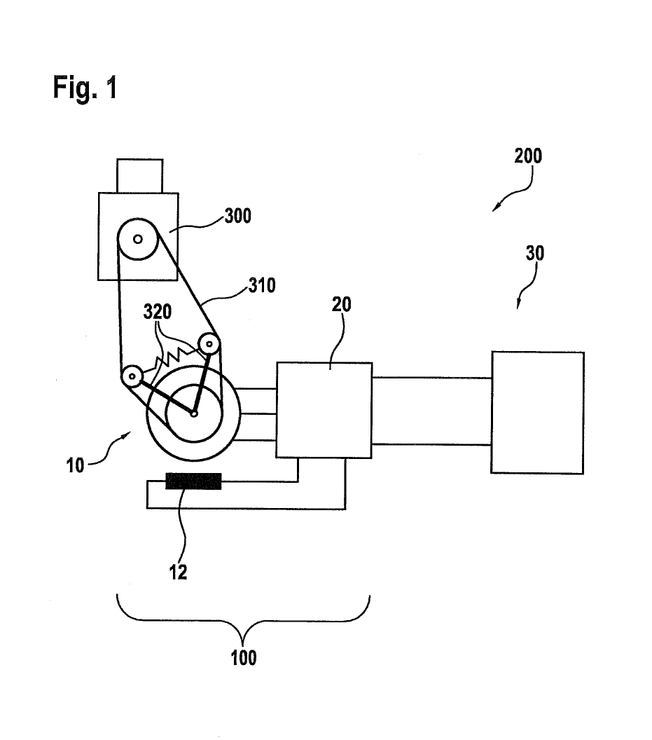

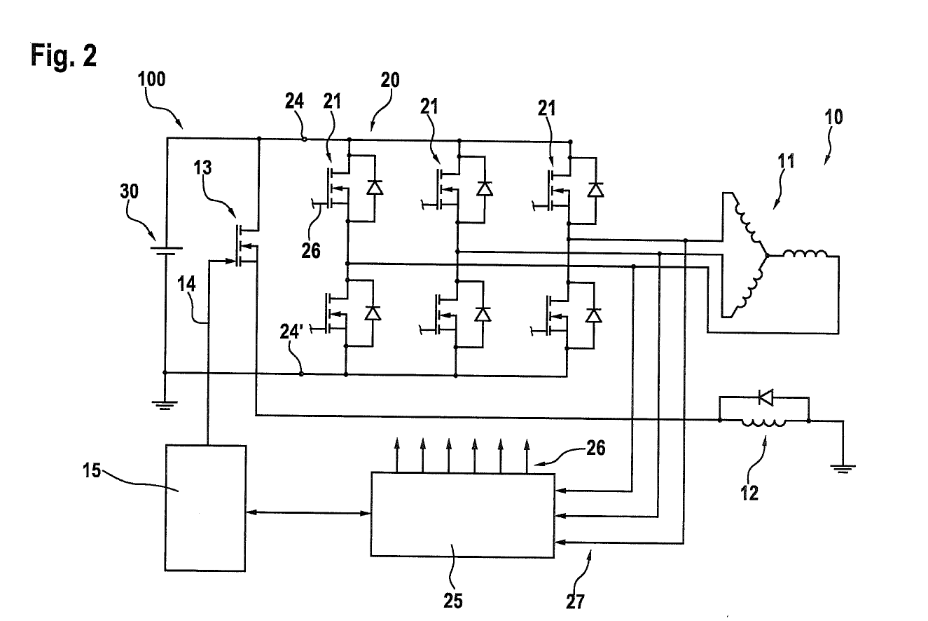

The present invention is described in the following with reference to FIGS. 1 and 2 in which identical elements are provided with identical reference numerals.

In FIG. 1, a system 200 including an internal combustion engine 300, a belt-driven starter generator 100 as the electric machine, and a vehicle electrical system 30 are illustrated, based on which one specific embodiment of the present invention is elucidated.

Internal combustion engine 300 is connected to starter generator 100 via a belt 310, a belt tensioner being provided which is configured as a reciprocating belt tensioning system 320 and which is capable of tensioning belt 310 during operation independently of the torque direction.

In FIG. 2, starter generator 100 is provided in the form of a circuit diagram. The starter generator has a generator component 10 and a current converter component 20. The current converter component is usually operated as a rectifier during the generator-based operation of the machine and as an inverter during the engine-based operation.

Generator component 10 is illustrated only schematically in the form of stator windings 11 which are interconnected in a star-shaped manner and in the form of an excitation or rotor winding 12 which is connected in parallel to a diode. The rotor winding is switched in a clocked manner with the aid of a power switch 13 which is connected to a terminal 24 of current converter component 20. The activation of power switch 13 takes place via an activation line 14 according to a field controller 15, power switch 13 being generally integrated into an application-specific integrated circuit (ASIC) of the field controller similarly to the diode which is connected in parallel to rotor winding 12. The excitation current may be set via a pulse-width modulated voltage signal, an excitation current flowing at a nominal current intensity in the case of permanent activation (i.e., a duty cycle of 100% or 1). After setting a duty cycle of 100%, the nominal current intensity is only reached with a certain delay of up to five rotor winding time constants due to the great inductance of the rotor winding.

Within the scope of the present application, a three-phase generator is illustrated. In principle, the present invention is, however, also applicable in the case of generators having fewer or more phases, e.g., five-phase generators. The stator winding time constant is typically considerably shorter than the rotor winding time constant.

Current converter component 20 is implemented in this case as a B6 circuit and has switching elements 21 which may be implemented as MOSFETs 21, for example. MOSFETs 21 are, for example, connected via busbars to particular stator windings 11 of the generator. Furthermore, the MOSFETs are connected to terminals 24, 24′ and make available a direct current for a vehicle electrical system 30 including the battery of a motor vehicle if accordingly activated. The activation of switching elements 21 takes place with the aid of an activation device 25 via activation channels 26, not all of which being provided with reference numerals for the sake of clarity. Activation direction 25 receives the phase voltage of the individual stator windings via phase channels 27 in each case. In order to provide these phase voltages, additional devices may be provided which are, however, not illustrated for the sake of clarity.

During engine operation, starter generator 100 is used in order to start up internal combustion engine 300. Here, current converter component 20 according to one embodiment of the present invention is operated in a manner which is described as follows. The starter generator is supplied with power by the battery.

If, at this point in time, rotor winding 12 is essentially de-energized, i.e., the excitation current is below a lower threshold value of 10% of the nominal current, for example, (corresponds to approximately 1 A), rotor winding 12 is initially energized in that a duty cycle of 100% is set by field controller 15, in particular. The current flow through the rotor winding and thus the excitation field increases according to the known switching behavior in the case of inductances.

This increase of the excitation field is transferred to a desirable increase of the torque in that stator winding 11 is also energized very early. This may take place before the excitation current reaches an upper threshold value of 25% of the nominal current, for example. It is known that the current flowing through a de-energized coil reaches approximately 63.2% of the nominal current after one time constant and approximately 99.3% of the nominal current after five time constants. Stator winding 11 may be energized within or approximately at a quarter of a time constant and no later than within or approximately at two time constants.

The energization of stator winding 11 may take place during an unclocked (so-called block operation) or a clocked (so-called pulse-width modulated (PWM) operation) pulse-controlled inverter operation. The selected activation pattern may be selected in this case independently of the rotational speed and the desirable torque. In the case of the block commutation, the semiconductor switches remain permanently switched on for the time period of a phase activation in contrast to the pulse-width modulated operation. During the pulse-width-modulated operation, the semiconductor switches may be activated at a high frequency (typically between 2 kHz and 20 kHz) using a specific activation pattern, which causes a harmonic progression of the phase current, thus resulting in a reduced torque waviness and an improved efficiency. Both methods are well known from the related art.

At the output of the starter generator, a minor torque is initially established which increases as a function of the time constant of the rotor winding. The mechanical tension in the drive of belt 310 increases proportionally to the torque, whereby a force is slowly applied to reciprocating belt tensioning system 320. The fact that this force is not increased joltily results in reciprocating belt tensioning system 320 slowly ceasing vibration and thus in a reduced occurrence of noises and vibrations. If the belt is tensioned after a certain period of time and the torque is sufficiently large, the crankshaft of internal combustion engine 300 is accelerated, thus resulting in a start-up.

If at the point in time mentioned above, rotor winding 12 is also significantly energized, i.e., the excitation current is above the lower threshold value of approximately 10%, rotor winding 12 is initially also energized in that a duty cycle of 100% is set by field controller 15, in particular. The excitation field is, however, already high enough for an undesirably high torque to already result in the case of the above-described energization of the stator winding. For this reason, stator winding 11 may be energized in such a way that a slow torque increase results again. The energization of stator winding 11 may take place in this case during a clocked (so-called PWM operation) pulse-controlled inverter operation. The selected activation pattern may be selected in this case independently of the rotational speed and the desirable torque.

In the two cases described above, a ramp-shaped increase of the torque may be achieved, the rise of the torque ramp being predefined as a function of the type of operation and the ramps also being different for the two cases described above.

1-11. (canceled)

12. A method for preparing a start-up of an internal combustion engine with the aid of a belt-driven starter generator, which includes a stator winding and a rotor winding, the method comprising:
operating the starter generator so that its generated torque increases slowly over a time duration of more than two rotor winding time constants, wherein the rotor winding is initially energized and a beginning of an energization of the stator winding occurs as a function of at least one of (i) an excitation current flowing through the rotor winding, and (ii) time.

13. The method of claim 12, wherein the stator winding is energized so that the generated torque increases slowly over a time duration of more than two rotor winding time constants.

14. The method of claim 13, wherein if the excitation current flowing through the rotor winding is below a lower threshold value prior to the beginning of its energization, the stator winding is energized before the excitation current is above an upper threshold value.

15. The method of claim 13, wherein if the excitation current flowing through the rotor winding is below a lower threshold value prior to the beginning of its energization, the stator winding is also energized within no more than two of a rotor winding time constant after the beginning of the energization of the rotor winding.

16. The method of claim 14, wherein the stator winding is subjected to a block-commutated supply voltage for the energization.

17. The method of claim 12, wherein if the excitation current flowing through the rotor winding is above a lower threshold value prior to the beginning of its energization, the stator winding is subjected to a PWM-commutated supply voltage for the energization.

18. The method of claim 12, wherein the rotor winding is energized at a duty cycle of at least 50%.

19. The method of claim 12, wherein the internal combustion engine is started by the belt-driven starter generator.

20. An arithmetic unit, comprising:
an arithmetic unit arrangement configured for preparing a start-up of an internal combustion engine with the aid of a belt-driven starter generator, which includes a stator winding and a rotor winding, by performing the following:
operating the starter generator so that its generated torque increases slowly over a time duration of more than two rotor winding time constants, wherein the rotor winding is initially energized and a beginning of an energization of the stator winding occurs as a function of at least one of (i) an excitation current flowing through the rotor winding, and (ii) time.

21. A computer-readable data medium having a computer program, which is executable by a processor, comprising:
a program code arrangement having program code for preparing a start-up of an internal combustion engine with the aid of a belt-driven starter generator, which includes a stator winding and a rotor winding, by performing the following:
operating the starter generator so that its generated torque increases slowly over a time duration of more than two rotor winding time constants, wherein the rotor winding is initially energized and a beginning of an energization of the stator winding occurs as a function of at least one of (i) an excitation current flowing through the rotor winding, and (ii) time.

22. The computer-readable data medium of claim 21, wherein the stator winding is energized so that the generated torque increases slowly over a time duration of more than two rotor winding time constants.

23. The method of claim 13, wherein if the excitation current flowing through the rotor winding is below a lower threshold value prior to the beginning of its energization, the stator winding is also energized within no more than one rotor winding time constant after the beginning of the energization of the rotor winding.

24. The method of claim 13, wherein if the excitation current flowing through the rotor winding is below a lower threshold value prior to the beginning of its energization, the stator winding is also energized within no more than a quarter of a rotor winding time constant after the beginning of the energization of the rotor winding.

25. The method of claim 12, wherein the rotor winding is energized at a duty cycle of at least 75%.

26. The method of claim 12, wherein the rotor winding is energized at a duty cycle of at least 90%.

27. The method of claim 12, wherein the rotor winding is energized at a duty cycle of at least 100%.
